(19) United States
(12) Patent Application Publication
(10) Pub. No.: US 2004/0128342 A1
(43) Pub. Date: Jul. 1, 2004

(54) System and method for providing multi-modal interactive streaming media applications

(75) Inventors: Stephane H. Maes, Redwood Shores, CA (US); Ganesh N. Ramaswamy, Ossining, NY (US)

Correspondence Address: Frank Chau, F. CHAU & ASSOCIATES, LLP, Suite 501, 1900 Hempstead Turnpike, East Meadow, NY, 11554, US

(73) Assignee: International Business Machines Corporation, Armonk, NY

(21) Appl. No.: 10/335,039

(22) Filed: Dec. 31, 2002

(51) Int. Cl. G06F 15/16

(52) U.S. Cl. 709/200

(57) ABSTRACT

A system and method for generating streamed broadcast or multimedia applications that offer multi-modal interaction with the content of a multimedia presentation. Mechanisms are provided for enhancing multimedia broadcast data by adding and synchronizing low bit rate meta-information which preferably implements a multi-modal user interface. The meta information associated with video or other streamed data provides a synchronized multi-modal description of the possible interaction with the content. The multi-modal interaction is preferably implemented using intent-based interaction pages that are authored using a modality-independent script.

### BACKGROUND

1. Technical Field

The present invention relates generally to systems and methods for implementing interactive streaming media applications and, in particular, to systems and methods for incorporating/associating encoded meta information with a streaming media application to provide a user interface that enables a user to control and interact with the application and a streaming media presentation in one or more modalities.

2. Description of Related Art

The computing world is evolving towards an era where billions of interconnected pervasive clients will communicate with powerful information servers. Indeed, this millennium will be characterized by the availability of multiple information devices that make ubiquitous information access an accepted fact of life. This evolution towards billions of pervasive devices being interconnected via the Internet, wireless networks or spontaneous networks (such as Bluetooth and Jini) will revolutionize the principles underlying man-machine interaction. In the near future, personal information devices will offer ubiquitous access, bringing with them the ability to create, manipulate and exchange any information anywhere and anytime using interaction modalities most suited to the user's current needs and abilities. Such devices will include familiar access devices such as conventional telephones, cell phones, smart phones, pocket organizers, PDAs and PCs, which vary widely in the interface peripherals they use to communicate with the user. At the same time, as this evolution progresses, users will demand a consistent look, sound and feel in the user experience provided by these various information devices.

The increasing availability of information, along with the rise in the computational power available to each user to manipulate this information, brings with it a concomitant need to increase the bandwidth of man-machine communication. The ability to access information via a multiplicity of appliances, each designed to suit the user's specific needs and abilities at any given time, necessarily means that these interactions should exploit all available input and output (I/O) modalities to maximize the bandwidth of man-machine communication. Indeed, users of information appliances will benefit from multi-channel, multi-modal and/or conversational applications, which will maximize the user's interaction with such information appliances in hands free, eyes-free environments.

The term “channel” used herein refers to a particular renderer, device, or a particular modality. Examples of different modalities/channels comprise, e.g., speech such as VoiceXML), visual (GUI) such as HTML (hypertext markup language), restrained GUI such as WML (wireless markup language), CHTML (compact HTML), and HDML (handheld device markup language), XHTML—MP (mobile profile) and a combination of such modalities. The term “multi-channel application” refers to an application that provides ubiquitous access through different channels (e.g., VoiceXML, HTML), one channel at a time. Multi-channel applications do not provide synchronization or coordination across the different channels.

The term “multi-modal” application refers to multi-channel applications, wherein multiple channels are simultaneously available and synchronized. Furthermore, from a multi-channel point of view, multi-modality can be considered another channel.

Furthermore, the term “conversational” or “conversational computing” as used herein refers to seamless multi-modal dialog (information exchanges) between user and machine and between devices or platforms of varying modalities (I/O capabilities), regardless of the I/O capabilities of the access device/channel, preferably, using open, interoperable communication protocols and standards, as well as a conversational (or interaction-based) programming model that separates the application data content (tier 3) and business logic (tier 2) from the user interaction and data model that the user manipulates. The term “conversational application” refers to an application that supports multi-modal, free flow interactions (e.g., mixed initiative dialogs) within the application and across independently developed applications, preferably using short term and long term context (including previous input and output) to disambiguate and understand the user's intention. Conversational applications preferably utilize NLU (natural language understanding).

The current networking infrastructure is not configured for providing seamless, multi-channel, multi-modal and/or conversational access to information. Indeed, although a plethora of information can be accessed from servers over a network using an access device (e.g., personal information and corporate information available on private networks and public information accessible via a global computer network such as the Internet), the availability of such information may be limited by the modality of the client/access device or the platform-specific software application with which the user interacts to obtain such information.

For instance, streaming media service providers generally do not offer seamless, multi-modal access, browsing and/or interaction. Streaming media comprises live and/or archived audio, video and other multimedia content that can be delivered in near real-time to an end user computer/device via, e.g., the Internet. Broadcasters, cable and satellite service providers offer access to radio and television (TV) programs. On the Internet, for example, various web sites (e.g., Bloomberg TV or Broadcast.com) provide broadcasts from existing radio and television stations using streaming sound or streaming media techniques, wherein such broadcasts can be downloaded and played on a local machine such as a television or personal computer.

Service providers of streaming multimedia, e.g., interactive television and broadcast on demand, typically require proprietary plug-ins or renderers to playback such broadcasts. For instance, the WebTV access service allows a user to browse Web pages using a proprietary WebTv browser and hand-held control, and uses the television as an output device. With WebTV, the user can follow links associated with the program (e.g., URL to web pages) to access related meta-information (i.e., any relevant information such as additional information or raw text of a press release or pages of related companies or parties, etc.). WebTv only associates a given broadcast program to a separate related web page. The level of user interaction and I/O modality provided by a service such as WebTv is limited.

With the rapid advent of new wireless communication protocols and services (e.g., GPRS (general packet radio services), EDGE (enhanced data GSM environment), NTT DoCoMo's i-mode, etc.) that support multimedia streaming and provide fast, simple and inexpensive information access, the use of streamed media will become a key component of the Internet. The use of streamed media will be further enhanced with the advent and continued innovations in cable TV, cable modems, satellite TV and future digital TV services that offer interactive TV.

Accordingly, systems and methods that would enable users to control and interact with steaming applications and streaming media presentations, in one or more modalities, are highly desirable.

### SUMMARY OF THE INVENTION

The present invention relates generally to systems and methods for implementing interactive streaming media applications and, in particular, to systems and methods for incorporating/associating encoded meta information with a streaming media application to provide a user interface that enables a user to control and interact with the application and streaming presentation in one or more modalities.

Mechanisms are provided for enhancing multimedia broadcast data by adding and synchronizing low bit rate meta information which preferably implements a conversational or multi-modal user interface. The meta information associated with video or other streamed data provides a synchronized multi-modal description of the possible interaction with the content.

In one aspect of the present invention, a method for implementing a multimedia application comprises associating content of a multimedia application to one or more interaction pages, and presenting a user interface that enables user interactivity with the content of the multimedia application using an associated interaction page.

In another aspect of the invention, the interaction pages are rendered to present a multi-modal interface that enables user interactivity with the content of a multimedia presentation in a plurality of modalities. Preferably, interaction in one modality is synchronized all modalities of the multi-modal interface.

In another aspect of the invention, the content of a multimedia presentation is associated with one or more interaction pages via mapping information wherein a region of the multimedia application is mapped to one or more interaction pages using a generalized image map. An image map may be described across various media dimensions such as X-Y coordinates of an image, or t(x,y) when a time dimension is present, or Z(X,Y) where Z can be another dimension such as a color index, a third dimension, etc. In a preferred embodiment, the mapped regions of the multimedia application are logically associated with data models for which user interaction is described using a modality independent, single authoring. interaction-based programming paradigm.

In another aspect of the invention, the content of a multimedia application is associated with one or more interaction pages by transmitting low bit rate encoded meta information with a bit stream of the multimedia application. The low bit rate encoded meta information may be transmitted in band or out of band. The encoded meta information describes a user interface that enables a user to control and manipulate streamed content, control presentation of the multimedia application and/or control a source (e.g., server) of the multimedia application. The user interface may be implemented as a conversational, multi-modal or multi-channel user interface.

In another aspect of the invention, different user agents may be implemented for rendering multimedia content and an interactive user interface.

In another aspect of the invention, the interaction pages, or fragments thereof, are updated during a multimedia presentation using one of various synchronization mechanisms. For instance, a synchronizing application may be implemented to select appropriate interaction pages, or fragments thereof, as a user interacts with the multimedia application. Further, event driven coordination may be used for synchronization based on events that are thrown during a multimedia presentation.

These and other aspects, features, and advantages of the present invention will become apparent from the following detailed description of the preferred embodiments, which is to be read in connection with the accompanying drawings.

### DESCRIPTION OF THE DRAWINGS

FIG. 1 is a block diagram of a system according to an embodiment of the invention for implementing a multi-modal interactive streaming media application.

FIG. 2 is a diagram illustrating an application framework for implementing a multi-modal interactive streaming media application according to an embodiment of the invention.

FIG. 3 is a flow diagram of a method according to one aspect of the present invention for providing a multi-modal interactive streaming media application according to one aspect of the invention.

### DETAILED DESCRIPTION OF PREFERRED EMBODIMENTS

The present invention is directed to systems and methods for implementing streaming media applications (audio, video, audio/video, etc.) having a UI (user interface) that enables user interaction in one or more modalities. More specifically, the invention is directed to multi-channel, multi-modal, and/or conversational frameworks for streaming media applications, wherein encoded meta information is incorporated within, or associated/synchronized with, the streaming media bit stream, to thereby enable user control and interaction with a streaming media application and streaming media presentation, in one or more modalities. Advantageously, a streaming media application according to the present invention can be implemented in Web servers or Conversational portals to offer universal access to information and services anytime, from any location, using any pervasive computing device regardless of its I/O modality.

Generally, in one embodiment, low bit rate encoded meta information, which describes a user interface, can be added to the bit stream of streaming media (audio stream, video stream, audio/video stream, etc.). This meta information enables a user to control the steaming application and manipulate streamed multimedia content via multi-modal, multi-channel, or conversational interactions.

More specifically, in accordance with various embodiments of the invention, the encoded meta-information for implementing a multi-modal user interface for a streaming application may be transmitted “in band” or “out of band” using the methods and techniques disclosed, for example, in U.S. patent application Ser. No. 10/104,925, filed on Mar. 21, 2002, entitled “Conversational Networking Via Transport, Coding and Control Conversational Protocols,” which is commonly assigned and fully incorporated herein by reference. This application describes novel real time streaming protocols for DSR (distributed speech recognition) applications, and protocols for real time exchange of control information between distributed devices/applications.

More specifically, in one exemplary embodiment, the meta-information can be exchanged “in band” using, e.g., RTP (real time protocol), SIP (session initiation protocol) and SDP (Session Description Protocol)(or other streaming environments such as H.323 that comprises a particular codec/media negotiation), wherein the meta-information is transmitted in RTP packets in an RTP stream that is separate from an RTP stream of the streaming media application. In this embodiment, SIP/SDP can be used to initiate and control several sessions simultaneously for sending the encoded meta information and streamed media in synchronized, separate sessions (between different ports). The meta-information can be sent via RTP, or other transport protocols such as TCP, UDP, HTTP, SIP or SOAP (over TCP, SIP, RTP, HTTP, etc.) etc.

Alternatively, for “in band” transmission, the meta-information can be transmitted in RTP packets that are interleaved with the RTP packets of the streaming media application using a process known as “dynamic payload switching”. In particular, SIP and SDP can be used to initiate a session with multiple RTP payloads, which are either registered with the IETF or dynamically defined. For example, SIP/SDP can be used to initiate the payloads at the session initiation to assign a dynamic payload identifier that can then be used to switch dynamically by changing the payload identifier (without establishing a new session through SIP/SDP). By way of example, the meta-information may be declared in SDP as:

m=text 3400 RTP/AVT 102 xml charset=“utf-8”,

(where 102 means that it is associated to payload 102), with a dynamic codec switch through dynamic change of payload type without any signalling information. As is known in the art, SDP describes multimedia sessions for the purpose of session announcement, session invitation and other forms of multimedia session initiation.

In another embodiment, in band exchange of meta-information can be implemented via RTP/SIP/SDP by repeatedly initiating another session established respectively by a SIP re-INVITE or a SIP INVITE method to change the payload. If the interaction changes frequently, however, this method may not be efficient.

In other embodiments, the meta-information may be transmitted “out-of-band” by piggybacking the meta information on top of the session control channel using, for example, extensions to RTCP (real time control protocol), SIP/SDP on top of SOAP, or as part of any other suitable extensible mechanism (e.g., SOAP (or XML or pre-established messages) over SIP or HTTP, etc.). Such out of band transmission affords the advantages such as (i) using the same ports and piggy back on a supported protocol that will be able to pass end-to-end across the infrastructure (gateways and firewalls), (ii) providing guarantee of delivery, and (iii) no reliance on mixing payload and control parameters.

Regardless of the protocols used for transmitting the encoded meta-information, it is preferable that such protocols are compatible with communication protocols such as VoIP (voice over Internet protocol), streamed multimedia, 3G networks (e.g., 3GPP), MMS (multimedia services), etc. With other networks such as digital or analog TV, radio, etc., the meta-information can be interleaved with the signal in the same band (e.g., using available space within the frequency bands or other frequency bands, etc.).

It is to be appreciated that the above approaches can be used with different usage scenarios. For example, a new user agent/terminal can be employed to handle the different streams or multimedia as an appropriate representation and generate the associate user interface.

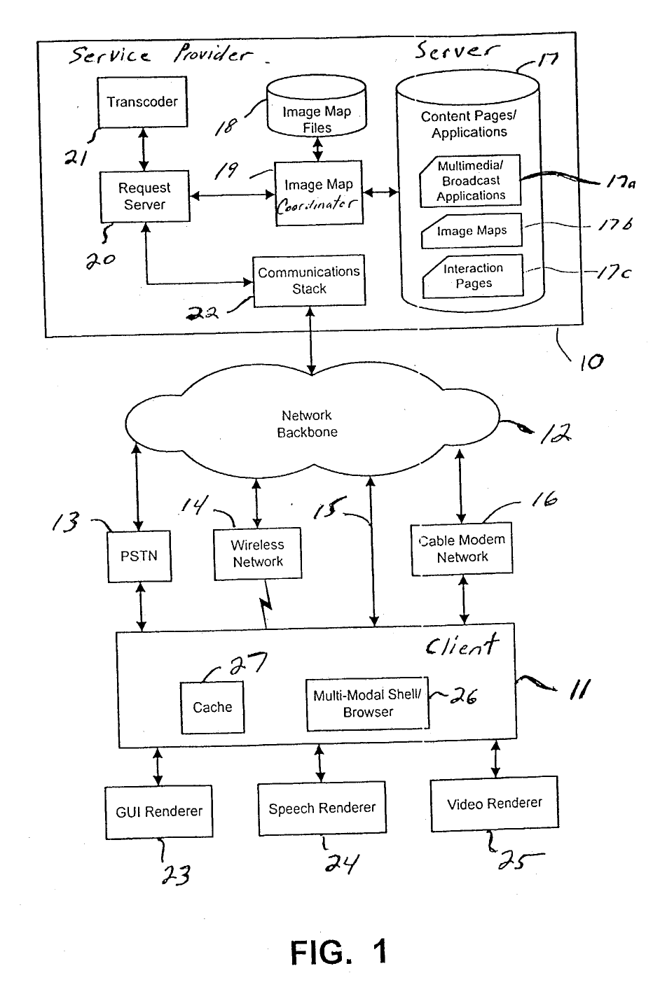

Alternatively, different user agents may be employed wherein one agent is used for rendering the streamed multimedia and another agent (or possibly more) is used for providing an interactive user interface to the user. A multi-agent framework would be used, for example, with TV programs, monitors, wall mounted screens, etc., that display a multimedia (analog and digital) presentation that can be interacted with using one or more devices such as PDAs, cell phones, PC, tablet, PC, etc. It is to be appreciated that the implementation of user agents enables new devices to drive an interaction with legacy devices such as TVs, etc. It is to be further appreciated that if a multimedia display device can interface with a device (or devices) that drives the user interaction, it is possible that the user not only interacts with the application based on what is provided by the streamed multimedia, but also directly affects the multimedia presentation/rendering (e.g., highlight items) or source (controls what is being streamed and displayed). For example, as in FIG. 1, a multi-modal browser 26 can interact with either a video renderer 25 or with a server (source) 10 to affect what is streamed to the renderer 25.

It is to be further appreciated that an interactive multimedia application with multi-modal/multi-device interface according to the invention may comprise an existing application that is extended with meta-information to provide interaction as described above. Alternatively, a multimedia application may comprise a new application that is authorized from the onset to provide user interaction.

It is to be appreciated that the systems and methods described herein preferably support programming models that are premised on the concept of “single-authoring” wherein content is expressed in a “user-interface” (or modality) neutral manner. More specifically, the present invention preferably supports “conversational” or “interaction-based” programming models that separate the application data content (tier 3) and business logic (tier 2) from the user interaction and data model that the user manipulates. An example of a single authoring, interaction-based programming paradigm that can be implemented herein is described in U.S. patent application Ser. No. 09/544,823, filed on Apr. 6, 2000, entitled: “Methods and Systems For Multi-Modal Browsing and Implementation of A Conversational Markup Language”, which is commonly assigned and fully incorporated herein by reference.

In general, U.S. Ser. No. 09/544,823 describes a novel programming paradigm for an interaction-based CML (Conversational Markup Language)(alternatively referred to as IML (Interaction Markup Language)). One embodiment of IML preferably comprises a high-level XML (extensible Markup Language)-based script for representing interaction “dialogs” or “conversations” between user and machine, which is preferably implemented in a modality-independent, single authoring format using a plurality of “conversational gestures.” The conversational gestures comprise elementary dialog components (interaction-based elements) that characterize the dialog interaction with the user. Each conversational gesture provides an abstract representation of a dialog independent from the characteristics and UI offered by the device or application that is responsible for rendering the presentation material. In other words, the conversational gestures are modality-independent building blocks that can be combined to represent any type of intent-based user interaction. A gesture-based IML, which encapsulates man-machine interaction in a modality-independent manner, allows an application to be written in a manner which is independent of the content/application logic and presentation.

For example, as explained in detail in the above incorporated U.S. Ser. No. 09/544,823, a conversational gesture message is used to convey information messages to the user, which may be rendered, for example, as a displayed string or a spoken prompt. In addition, a conversational gesture select is used to encapsulate dialogs where the user is expected to select from a set of choices. The select gesture encapsulates the prompt, the default selection and the set of legal choices. Other conversational gestures are described in the above-incorporated Ser. No. 09/544,823. The IML script can be transformed into one or more modality-specific user interfaces using any suitable transformation protocol, e.g., XSL (extensible Style Language) transformation rules or DOM (Document Object Model).

In general, user interactions authored in gesture-based IML preferably have the following format:

```
<iml>
  <model id= “model_name”> ... /model>
  <interaction model_ref=“model_name” name=“name”. ...,/interaction.
</iml>
```

The IML interaction page defines a data model component (preferably based on the XFORMS standard) that specifies one or more data models for user interaction. The data model component of an IML page declares a data model for the fields to be populated by the user interaction that is specified by the one or more conversational gestures. In other words, the IML interaction page can specify the portions of the user interaction that is binded on the data model portion. The IML document defines a data model for the data items to be populated by the user interaction, and then declares the user interface that makes up the application dialogues. Optionally, the IML document may declare a default instance for use as the set of default values when initializing the user interface.

The data items are preferably defined in a manner that conforms to XFORMS DataModel and XSchema. The Data models are tagged with a unique id attribute, wherein the value of the id attribute is used as the value of an attribute, referred to herein as model_ref on a given gesture element, denoted interaction, to specify the data model that is to be used for the interaction. It is to be understood that other languages that capture data models and interaction may be implemented herein.

Referring now to FIG. 1, a block diagram illustrates a system according to an embodiment of the present invention for implementing a multi-modal interactive streaming media application comprising a multi-modal, multi-channel, or conversational a user interface. The system comprises a content server 10 (e.g., a Web server) that is accessible by a client system/device/application 11 over any one of a variety of communication networks. For instance, the client 11 may comprise a personal computer that can transmit access requests to the server 10 and download (or open a streaming session), e.g., streamed broadcast and multimedia content over a PSTN (public switched telephone network) 13 or wireless network 14 (e.g., 2G, 2.5G., 3G, etc..) 14 and the backbone of an IP network 12 (e.g., the Internet) or a dedicated TCP/IP or UDP connection 15. The client 11 may comprise a wireless device (e.g., cellular telephone, portable computer, PDA, etc.) that accesses the server 10 via the wireless network 14 (e.g., a WAP (wireless application protocol) service network) and IP link 12. Further, the client 11 may comprise a “set-top box” that is connected to the server 10 via a cable network 16 (e.g., a DOCSIS (data-over cable service interface)-compliant coaxial or hybrid-fiber/coax (HFC) network, MCNS (multimedia cable network system)) and IP link. It is to be understood that other “channels” and networks/connectivity can be used to implement the present invention and nothing herein shall be construed as a limitation of the scope of the invention.

The server 10 comprises a content database 17, a map file database 18, an image map coordinator 19, a request server 20, a transcoder 21, and a communications stack 22. In accordance with the present invention, the server 10 comprises protocols/mechanisms for incorporating/associating user interaction components (encoded meta-information) into/with a streaming multimedia application so as to enable, e.g., multi-modal interactivity with the multimedia content. As described above, one mechanism comprises incorporating low bit rate information into the segments/packets/datagrams of a broadcast or multimedia data stream to implement an active conversational or multi-modal or multi-channel UI (user interface).

The content database 17 stores streaming multimedia and broadcast applications and content, as well as business logic associated with the applications, transactions and services supported by the server 10. More specifically, the database 17 comprises one or more multimedia applications 17a, image maps 17b and interaction pages 17c. The multimedia applications 17a are associated with one or more image maps 17b. In one embodiment, the image maps 17b comprise meta information that defines and maps different regions of the multimedia presentation that provide interactivity.

The image maps 17b are overlaid with interaction pages 17c that describe the conversational (or multi-modal or multi-channel) interaction for the mapped regions of, e.g., a streamed multimedia application. In one preferred embodiment, the interaction pages are generated using an interaction-based programming language such as the IML described in the above-incorporated U.S. patent application Ser. No. 09/544,823, although any suitable interaction-based programming language may be employed to generate the interaction pages 17c. In other embodiments, the interaction pages may be generated using declarative scripts, imperative scripts, or a hybrid thereof.

In contrast to conventional HTML applications wherein mapped regions are logically associated solely to a URL (uniform resource locator), URI (Universal Resource Identifier), or a Web address that will be linked to when the user clicks on an given mapped area, the mapped regions of a multimedia application according to the present invention are logically associated with data models for which the interaction is preferably described using a interaction-based programming paradigm (e.g., IML). The meta information associated with the image map stream and associated interaction page stream collectively define the conversational interaction for a mapped area. For instance, in one preferred embodiment, the image maps define different regions of an image in a video stream with one or more data models that encapsulate the conversational interaction for the corresponding mapped region. Further, depending on the application, the image map may be described across one or more different media dimensions: X-Y coordinates of an image, or t(x,y) when a time dimension is present, or Z(X,Y) where Z can be another dimension such as a color index, a third dimension, etc.

As explained below, during a multimedia presentation, the user can activate the user interface for a given area in a multimedia image by clicking on (via a mouse) or otherwise selecting (via voice) the given area. For example, consider a case where the user can interact with a TV program by either voice, GUI or multi-modal interaction. The user can identify items in the multimedia presentation and obtain different services associated with the presented items (e.g., a description of the item, what kind of information is available for the item, what services are provided, etc.). If the interaction device(s) can interface with the multimedia player(s)(e.g., TV display) or the multimedia source (e.g., set-top box or the broadcast source), then the multimedia presentation can be augmented by hints or effects that describe possible interactions or effects of the interaction (e.g., highlighting a selected element). Also, using a pointer or other mechanism, the user can preferably designate or annotate the multimedia presentation. These latter types of effects can be implemented by DOM events following an approach similar to what is described in U.S. patent application Ser. No. 10/007,092, filed on Dec. 4, 2001, entitled “Systems and Methods For Implementing Modular DOM (Document Object Model)-Based Multi-Modal Browsers”, and U.S. Provisional Application Serial No. 60/251,085, filed on Dec. 4, 2000, which are both fully incorporated herein by reference.

It is to be understood that the database 17 may further comprise applications and content pages authored in IML or modality-specific languages such as HTML, XML, WML, and VoiceXML. It is to be further understood that the content in database 17 may be distributed over the network 12. As described above, the content can be delivered over HTTP, TCP/IP, UDP, SIP, RTP, etc. The mechanism by which the content pages are distributed will depend on the implementation. The content pages are preferably associated/coordinated with the multimedia presentation using methods as described below.

The image map coordinator 19 utilizes map files stored in database 18 to incorporate or associate relevant interaction pages and image maps with a given multimedia stream. The image map files 18 comprise meta information regarding “active” areas of a multimedia application (e.g., content having interaction pages mapped thereto or particular controlling functions), the data models associated with the active areas and, possibly, target addresses (such as URLs) to link to other applications/pages or to a new page in a given application. This is also valid if the content is not device-independent (e.g., programmed via iML and Xforms) but authored directly in XHTML, VoiceXML, etc. The image map coordinator 19 is responsible for preparing the interaction content and sending it appropriately with respect to the streamed multimedia. The image map coordinator 19 performs functions such as generation/push and coordination/synchronization of the interaction pages with the played multimedia presentation(s). The image map coordinator 19 function can be located on an intermediary or on a client device 11 instead of the server 10.

During presentation of a multimedia application, the image map coordinator 19 will update the user interaction by sending relevant interaction pages when the mapping changes as the user navigates through the application. The update process may comprise a periodic refresh or any suitable dedicated scheme. The image map coordinator 19 maps elements/objects/structures in the multimedia stream and presentation with interaction pages or fragments thereof. In one embodiment, time dimension is part of the generalized image map, whereby the image map coordinator 19 drives the selection by the server 10 based on the next interaction page to send. In other embodiments, the selection of interaction pages is performed via stored synchronized multimedia, wherein pre-stored files with multimedia and interaction payload are appropriately interleaved, or as described herein, stored interaction application(s) can be used to appropriately control the multimedia presentation.

Note also that an image map (or a fragment thereof) can also be sent to client 11 or video renderer 25 to enable client-side selection and allow the user actions to be reflected in the multimedia presentation (e.g., highlight the clickable object selected by user or provide hint/URL information in the document).

The update of the interaction content may be implemented in different manners. For example, in one embodiment, differential changes of images maps and iML document can be sent when appropriate (wherein the difference of the image map file is encoded or fragments of XML document are sent). Further, new image maps and XML documents can be sent when the changes are significant.

There are various methods that may be implemented in accordance with the present invention for the interaction pages to be synchronized/coordinated with the multimedia presentation. For example, time marks can be used that match the multimedia streamed data. Further, frame/position marks can be used that match the multimedia stream. Moreover, event driven coordination may be implemented, wherein a multimedia player throws events that are generated by rendering the multimedia. These events result into having the interaction device(s) load (or being pushed) new pages using, for example, mechanisms similar to the synchronization mechanisms disclosed in U.S. patent application No. 10/007,092. Events can be thrown by the multimedia player or they can be thrown on the basis of events sent (e.g., payload switch) with the RTP stream and intercepted/thrown by the multimedia player upon receipt or by an intermediary/receiver of that payload.

Further, positions in the streamed payload (e.g., payload switch) can be used to describe the interaction content or to throw events. In another embodiment, the interaction description can be sent in a different channel (in-band or out-of-band) and the time of delivery is indicative of the coordination that should be implemented (i.e., relying on the delivery mechanisms to ensure appropriate synchronized delivery when needed).

Further, with the W3C SMIL(1.0 and 2.0) specifications, for example, instead of being associated to the multimedia stream(s), XML interaction content can be actually driving the multimedia presentation. In other words, from the onset, the application is authored in XML (or other mechanisms to author an interactive application e.g. Java, C++, ActiveX, etc..), wherein one or multiple multimedia presentations are loaded, executed and controlled with mechanisms such as SMIL or as described in the above-incorporated U.S. patent application Ser. No. 10/007,092.

The underlying principles of the present invention are fundamentally different than other applications such as SMIL, Flash, Shockwave, Hotmedia etc. In accordance with the present invention, when the user interacts with an interaction page that is synchronized with the multimedia stream and presentation, the interaction may have numerous effects. For instance, the user interaction may affect the rendered multimedia presentation. Further, the user interaction may affect the source and therefore what is being streamed—the interaction controls the multimedia presentation. Further, the user interaction may result into starting a new application or series of interactions that may or may not affect the multimedia presentation. For example, the user may obtain information about an item presented in the multimedia presentation, and then decide to buy the item and then browse the catalog of the vendor. These additional interactions may or may not execute in parallel with the multimedia presentation. The interactions may be paused or stopped. The interactions can also be recorded by a server, intermediary or client and subsequently resumed at a later time. The user interaction may be subsequently affected by the user when reaching the end of the interaction or at any time during the interaction (i.e., while the user navigates further by interacting for example in an uncoordinated manner, the interaction pages or interaction devices continue to maintain and update interaction option/page/fragments coordinated with the multimedia streams. These may be accessible and presented at the same time as the application (e.g., other GUI frame) or accessed at any time by an appropriate link or command. This behavior may be decided on the fly by the user, be based on user preferences or imposed by device/renderer capabilities or imposed on the server by the service provider.

The request server 20 (e.g., an HTTP server, WML server, etc.) receives and processes access requests from the client system 11. In a preferred embodiment, the request server 20 detects the channel and the capability of the client browser and/or access device to determine the modality (presentation format) of the requesting client. This detection process enables the server 10 to operate in a multi-channel mode, whereby an IML page is transcoded to a modality-specific page (e.g., HTML, WML, Voice XML, etc.) that can be rendered by the client device/browser. The access channel or modality of the client device/browser may be determined, for example, by the type of query or the address requested (e.g., a query for a WML page implies that the client is a WML browser), the access channel (e.g. a telephone access implies voice only, a GPRS network access implies voice and data capability, and a WAP communication implies that access is WML), user preferences (a user may be identified by the calling number, calling IP, biometric, password, cookies, etc.), other information captured by the gateway in the connection protocol, or any type of registration protocols.

The transcoder module 21 may be employed in multi-channel mode to convert the interaction pages 17c for a given multimedia application to a modality-specific page modality) that is compatible with the client device/browser prior to being transmitted by the server 10, based on the detected modality by the request server 20. Indeed, as noted above, the meta information for the interaction page is preferably based on a single modality-independent model that can be transformed to appropriate modality-specific user interfaces, preferably in a manner that achieves synchronization across multiple controllers (e.g., speech and GUI browsers, etc.) as the controllers manipulate modality-specific views of the single modality-independent model. For example, application interfaces authored using gesture-based IML can be delivered to different devices such as desktop browsers and hand-held/wireless information appliances by transcoding the device-independent IML to a modality/device specific representation, e.g., HTML, WML, or VoiceXML.

It is to be understood that the streamed multimedia presentation may also be adapted based on the characteristics of the player. This may include format changes (AVI, MPEG, . . . , sequences of JPEG etc . . . ) and form factor. In some cases, if multiple multimedia renderer/players are available, it is possible to select the optimal renderer/device based on the characteristics/format of the multimedia presentations.

The communications stack 22 implements any suitable communication protocol for transmitting the image map and interaction page meta information for a given multimedia application. For example, using conventional broadcast models, the meta-information can be merged with the original broadcast signal using techniques similar to the method used for providing stereo forwarding in TV signals or the European approach of transmitting teletext pages on top of a TV channel. Preferably, with the evolution of VOIP (Voice over Internet Protocol) and streaming technology, the control layer of RTP streams (Real Time Protocols) that supports most of the broadcast mechanism (audio and video) (RTCP, RTSP, SIP and multimedia control as specified by 3GPP and IETF) are preferably utilized to ship an IML page with the mapped content using techniques as described, for example, in the above incorporated U.S. Ser. No. 10/104,925, or other streaming techniques as described herein. For example, in another embodiment, an additional RTP or socket connection can be instantiated to send a coordinated stream of interaction pages.

The client device 11 preferably comprises a multi-modal browser (or multi-modal shell) 26 that is capable of parsing and processing the interaction page of a given broadcast stream to generate one or more modality-specific scripts that are processed to present a user interface in one or more modalities. Preferably, as explained below, the use of the multi-modal browser 26 provides a tightly synchronized multi-modal description of the possible interaction specified by the interaction (IML) page associated with a multimedia application. The browser 26 can manipulate the multimedia player/renderer and it can also interact with the source 10.

It is to be understood that the invention should not be construed as being restricted to embodiments employing a multi-modal browser. Single modalities or devices and multiple devices can also be implemented. Also, these interfaces can be declarative, imperative or a hybrid thereof. Remote manipulation can be performed using engine remote control protocols using RTP control protocols (e.g. RTCP or RTSP extended to support speech engines) as disclosed in the above-incorporated U.S. patent application Ser. No. 10/104,925 or implementing speech engines and multimedia players as web services, such as described in U.S. patent application Ser. No. 10/183,125, filed on Jun. 25, 2002, entitled “Universal IP-Based and Scalable Architectures Across Conversational Applications Using Web Services,” which is commonly assigned and incorporated herein by reference.

The system of FIG. 1 comprises a plurality of rendering systems such as a GUI renderer 23 (e.g., HTML browser), a speech/audio renderer 24 (e.g., a VoiceXML browser) and video renderer 25 (e.g., a media player) for processing corresponding modality-specific scripts generated by the multi-modal browser 26. The rendering systems may comprise applications that are integrally part of the multi-modal browser 26 application or may comprise applications that reside on separate devices. By way of example, assuming the client system 11 comprises a “set-top” box, the GUI and video rendering systems 23, 25 may reside in the set-top box (using the television display as an output device), whereas the speech rendering system 24 may reside on a remote control. In this example, a television monitor can act as a display (output) device for displaying a graphical user interface (via an HMTL browser) and video and the remote control comprises a speaker/microphone and speech browser (e.g., VoiceXML browser) for implementing a speech interface that allows the user to interact with content via speech. For example, a user can issue speech commands to selection items displayed in a menu on the screen. In another example, the remote control may comprise a screen for displaying a graphical user interface, etc., that allows a user to interact with the displayed content on the television monitor. It is to be understood that video renderer 25 could be any multimedia player and that the different renderers 23, 24, 25 could be part of a same user agent or they could be distributed on different devices.

The client 11 further comprises a cache 27. The cache 27 is preferably implemented for temporarily storing one or more interaction pages or video frames that are extracted from a downloaded streamed broadcast. This allows stored video frames to be re-accessed when the interaction page is interacted with. It also allows possible recording of the streamed multimedia while the rendering is paused or when the user focuses on pursuing the interaction with a related application instead of resuming immediately the multimedia presentation. This is especially important with broadcasted/multi-casted multimedia.

Note the fundamental difference with past existing services such as TIVO and related applications. In the current invention, while interacting, a user can record a broadcasted session to resume the broadcasted session without losing content. This may require however a huge cache (several GB) to store the entire session depending on the format and duration of the service. Alternatively, such embodiment could consider the cache being located on an intermediary or on the server for more of a streaming in demand model. It is also possible to use the cache to buffer and cache multimedia sessions ahead of a possible interaction command contained in the interaction page. Methods are preferably implemented that enable recording of multimedia segments so that they can be processed by user (e.g., repeated, fed to automated speech recognition engines, recorded as a voice memo).

Various architectures and protocols for implementing a multi-modal browser or multi-modal shell are described in the above incorporated patent application Ser. Nos. 09/544,823 and 10/007,092, as well as U.S. patent application Ser. No. 09/507,526, filed on Feb. 18, 2000 entitled: “Systems And Methods For Synchronizing Multi-Modal Interactions”, which is commonly assigned and fully incorporated herein by reference. As described in the above incorporated applications, the multi-modal browser 26 comprises a platform for parsing and processing modality-independent scripts such as IML interaction pages. A multi-modal shell may be used for building local and distributed multi-modal browser applications, wherein a multi-modal shell functions as a virtual main browser that parses and processes multi-modal documents and applications to extract/convert the modality specific information for each registered mono-mode browser. A multi-modal shell can also be implemented for multi-device browsing, to process and synchronize views across multiple devices or browsers, even if the browsers are using the same modality. Again, it is to be understood that the invention is not limited to multi-modal cases, but also supports cases where a single modality or multiple devices are used to interact with the multimedia stream(s).

Techniques for processing the interaction pages (e.g., gesture-based IML applications and documents) via the multi-modal browser 26 are described in the above-incorporated U.S. patent application Ser. Nos. 09/507,526 and 09/544,823. For instance, in one embodiment, the content of an interaction page can be automatically transcoded to the modality or modalities supported by a particular client browser or access device using XSL (Extensible Stylesheet Language) transformation rules (XSLT). Using these techniques, an IML document can be converted to an appropriate declarative language such as HTML, XHTML, or XML (for automated business-to-business exchanges), WML for wireless portals and VoiceXML for speech applications and IVR systems (i.e., a single authoring for multi-channel applications). The XSL rules are modality specific and in the process of mapping IML instances to appropriate modality-specific representations, the XSL rules incorporate the information needed to realize modality-specific user interaction.

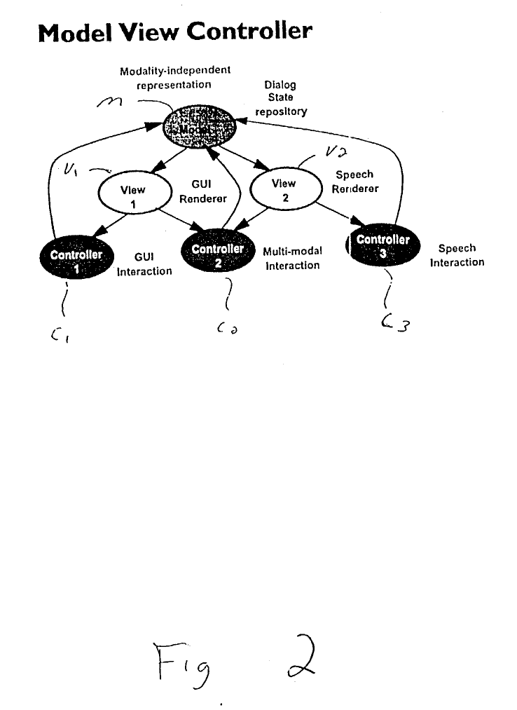

FIG. 2 is a diagram illustrating a preferred programming paradigm for implementing a multi-modal application (such as a multi-modal browser) in accordance with the above-described concepts. A multi-modal application is preferably based on a MVC (model-view-controller) paradigm as illustrated in FIG. 2, wherein a single information source, model M (e.g., gesture-based IML model) is mapped to a plurality of views (V1, V2) (e.g., different synchronized channels) and manipulated via a plurality of controllers C1, C2 and C3 (e.g., different browsers such as a speech, GUI and multi-modal browser). With this architecture, multi-modal systems are implemented using a plurality of controllers C1, C2, and C3 that act on, transform and manipulate the same underlying model M to provide synchronized views V1, V2 (i.e., to transform the single model M to multiple synchronous views). The synchronization of the views is achieved by generating all views from, e.g., a single unified representation that is continuously updated. For example, the single authoring, modality-independent (channel-independent) IML model as described above provides the underpinnings for coordinating various views such as speech and GUI. Synchronization is preferably achieved using an abstract tree structure that is mapped to channel-specific presentation tree structures. The transformations provide a natural mapping among the various views. These transformations can be inverted to map specific portions of a given view to the underlying modes. In other words, any portion of any given view can be mapped back to the generating portion of the underlying modality-independent representation and, in turn, the portion can be mapped back to the corresponding view in a different modality by applying the appropriate transformation rules.

In other embodiments of the invention, as discussed in the above incorporated U.S. patent application Ser. No. 10/007,092, entitled “Systems and Methods For Implementing Modular DOM (Document Object Model)-Based Multi-Modal Browsers”, other architectures can be used to implement (co-browser, master-slave, plug-in etc..) and author (e.g. naming convention, merged files, event-based merged files, synchronization tags..) multi-modal interactions.

In another embodiment of the invention, the image map coordinator (19) can be implemented as a MM shell_26, wherein a multimedia presentation could be considered as one of the views. The management of the coordination is then performed in a manner similar to the manner in which the multi-modal shell handles multiple authoring, such as described in the above-incorporated U.S. patent application Ser. No. 10/0007,092. As discussed in this application, the MM shell can be distributed across multiple systems (clients, intermediaries or server) so that the point of view presented above could in fact always be used even when the coordinator 19 is not the multi-modal shell.

In the exemplary embodiment of FIG. 1, the active UI of the broadcast or multimedia stream (i.e., the interaction pages associated with the mapped content) is processed by the multi-modal browser/shell 26. As noted above, in one embodiment, the multi-modal browser/shell 26 may be used for implementing multi-device browsing, wherein at least one of the rendering systems 23, 24 and 25 resides on a separate device. For example, assume that an IML page in a video stream enables a user to select a stereo, TV, chair, or sofa displayed for a given scene. Assume further that the client 11 is a set-top box and the GUI and video renderer 23, 25 reside in the set-top box with the TV screen used as a display and the active UI of an incoming broadcast stream is downloaded to a remote control device having the speech renderer 24. In this example, the user can use the remote control to interact with the content of the broadcast via speech by uttering an appropriate verbal command to select one or more of the displayed stereo, TV, chair, or sofa on the TV screen. Further, in this example, GUI actions corresponding to the verbal command can be synchronously displayed on the TV monitor, wherein the GUI interface and video overlay could be commonly displayed on top of or instead of the TV program. Alternatively, the multi-modal shell 26 can be implemented as a multi-modal browser on a single device, wherein the multi-modal browser supports the 3 views: the speech interface, GUI interface and video overlay. In particular, the multi-modal browser 26 and renderers 23-25 can reside within the client (e.g., a PC or wireless device).

Although FIG. 1 depicts the client system 11 comprising a multi-modal browser 26, it is to be understood that the client 11 may comprise a legacy browser (e.g., an HTML, WML, or VoiceXML browser) that is not capable of directly parsing and processing a modality-independent interaction page. In this situation, as noted above, the server 10 operates in “multi-channel” mode by using the transcoder 21 to convert a modality-independent interaction page into a modality-specific page that corresponds with the supported modality of the client 11. The transcoder 21 preferably implements the protocols described above (e.g., XSL transformation) for converting the modality-independent representation of the interaction page to the appropriate modality-specific representation. Again, there may be a scenario where only one modality is present to support the interaction and where the application was only authored for the one modality. For example, with respect to U.S. patent application Ser. No. 10/007,092, this corresponds to a multiple authoring approach (naming convention) where only one channel is authored or used.

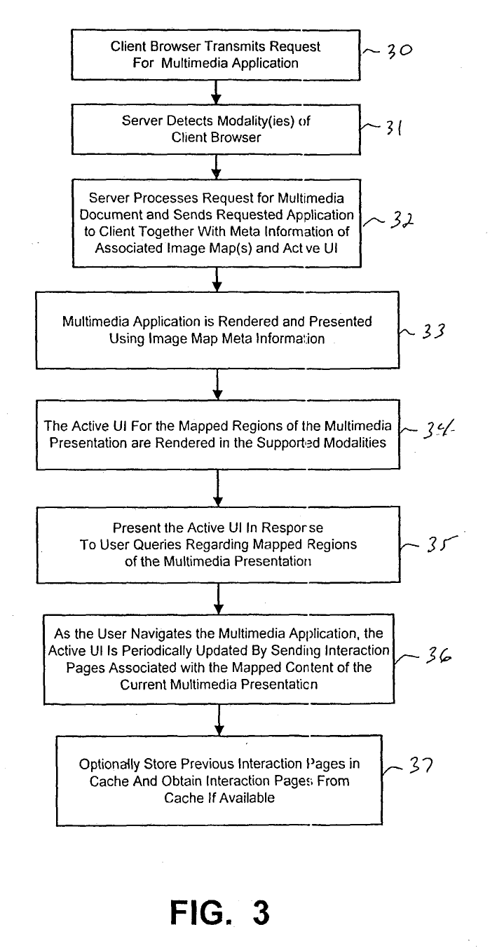

Referring now to FIG. 3, a flow diagram illustrates a method according to one aspect of the present invention for implementing a user interface for a multimedia application. A user accesses a multimedia application via a client system, which transmits the appropriate request over a network (step 30). As noted above, the client system may comprise, for example, a “set-top” box comprising a multi-modal browser, a PC having a multi-modal browser, sound card, video card and suitable media player, or a mobile phone comprising a WML/XHTML MP browser (other clients can be considered). A server receives the request and detects and identifies the supported modality of the client browser (step 31). As noted above, this detection process is preferably performed to determine whether the client system is capable of processing the modality-independent interaction pages which define the active user interface. The server will process the client request, which comprises transcoding the interaction pages from the modality-independent representation to a channel-specific representation if necessary, and then send the requested multimedia application (possibly also adapted to the multimedia player capabilities) together with the meta information of the associated image maps and active user interface (step 32). As noted above, the meta information may be directly incorporated within the multimedia stream or transmitted in real time in separate control packets that are synchronized with the multimedia stream.

The client system will receive the multimedia stream and render and present the multimedia application using the image map meta information and appropriate broadcast display system (e.g., media player)(step 33). By way of example, a video stream can be rendered and presented, wherein one or more image maps are associated with a video image. The active regions of the video stream will be mapped on a video screen. The user interface for a mapped region of the multimedia presentation is rendered in a supported modality (step 34). For example, assuming the client system comprises a set-top box comprising a multi-modal browser, as indicated above, the interaction pages (which describe the active user interface) can be rendered and presented in a GUI mode on the television screen and in a speech mode on a separate remote control device having a speech interface.

The user can then query what is available in the image and a description of the image or associated actions are presented, e.g., in multi-modal mode on the GUI and speech interface or in mono-modal mode (step 35) or directly on the multimedia presentation. Further, the user can interact with the multimedia content by selecting a mapped region (e.g., by clicking on the image, selecting by voice or both) to, e.g., obtain additional information, be forwarded to a vendor web site, or bookmark it for later ordering/investigation.

As the user navigates through the multimedia application, the active user interface is updated by the server sending interaction pages associated with the mapped content of the current multimedia presentation (step 36). Preferably, the associated browser or remote control device comprises a cache mechanism to store previous interaction pages so that cached interaction pages may accessed from the cache (step 37)(as opposed to downloading from the server). Furthermore, it is preferably that the broadcast display system buffers or saves some of the video frames so that when a IML page is interacted with, the underlying video frame is saved and re-accessible.

The present invention can be implemented with any multimedia broadcast application to provide browsing and multi-modal interactivity with the content of the multimedia presentation. For example, the present invention may be implemented with commercially available applications such as TiVo™, WebTV™, or Instant Replay™, etc.

Furthermore, in addition to providing interaction with the content of the multimedia presentation, the present invention can be used to offer the capability to the service provider to tune/edit the interaction that can be performed on the multimedia stream. Indeed, the service provider can dictate the interaction by modifying or generating IML pages that are associated with mapped regions of a multimedia or broadcast stream. Moreover, as indicated above, the use of IML provides an advantage to reuse existing legacy modality specific browser in a multi-channel mode or multi-modal or multi-device browser mode. In multi-modal and multi-device browser mode, an integrated and synchronized interaction can be employed.

It is to be appreciated that the present invention can be employed in an audio only stream, for example.

The multi-modal interactivity components associated with a multimedia application can be implemented using any suitable language and protocols. For instance, SMIL (Synchronized Multimedia Interaction Language), which is known in the art (see http://www.w3.org/AudioVideo/), can be used to enable multi-modal interactivity. SMIL enables simple authoring of multimedia presentations such as training courses on the Web. SMIL presentations can be written using a simple text-editor. A SMIL presentation can be composed of streaming audio, streaming video, images, text or any other media type. It consists of combining different audio stream, but does not provide a mechanism for associating an IML or interface page to manipulate the multimedia document. However, in accordance with the present invention, a SMIL document can be overlaid with and synchronized to an IML page to provide a user interface. Alternatively, an interaction page or IML can be authored via SMIL (or Shockwave or Hotmedia) to be synchronized to an existing SMIL (shockwave or hotmedia) presentation.

In another embodiment, the MPEG 4 protocol may be modified according to the teachings herein to provide multi-modal interactivity. The MPEG-4 protocol provides standardized ways to:

(1) represent units of aural, visual or audiovisual content, called “media objects”. These media objects can be of natural or synthetic origin (i.e., the media objects may be recorded with a camera or microphone, or generated with a computer;

(2) describe the composition of these objects to create compound media objects that form audiovisual scenes;

(3) multiplex and synchronize the data associated with media objects, so that they can be transported over network channels providing a QoS (quality of service) that is appropriate for the nature of the specific media objects; and

(4) interact with the audiovisual scene generated at the receiver's end.

The MPEG-4 coding standard can be used to add IML pages that are synchronized to a multimedia transmission, which are transmitted to a receiver.

Moreover, the MPEG-7 protocol will provide a standardized description of various types of multimedia information. This description will be associated with the content itself, to allow fast and efficient searching for material that is of interest to the user. MPEG-7 is formally called ‘Multimedia Content Description Interface’. The standard does not comprise the (automatic) extraction of descriptions/features. Nor does it specify the search engine (or any other program) that can make use of the description. Accordingly, the MPEG-7 protocol describes objects in a document for search purpose and indexing. The present invention may be implemented within the MPEG-7 protocol by having IML pages connected to the object descriptions provided by IML instead of providing its own description in the meta-information layer.

It is to be understood that the systems and methods described herein may be implemented in various forms of hardware, software, firmware, special purpose processors, or a combination thereof. In particular, the present invention is preferably implemented as an application comprising program instructions that are tangibly embodied on a program storage device (e.g., magnetic floppy disk, RAM, ROM, CD ROM, etc.) and executable by any device or machine comprising suitable architecture. It is to be further understood that, because some of the constituent system components and process steps depicted in the accompanying Figures are preferably implemented in software, the actual connections between such components and steps may differ depending upon the manner in which the present invention is programmed. Given the teachings herein, one of ordinary skill in the related art will be able to contemplate these and similar implementations or configurations of the present invention.

Although illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A method for implementing a multimedia application, comprising the steps of:
associating content of a multimedia application to one or more interaction pages; and
presenting a user interface that enables user interactivity with the content of the multimedia application using an associated interaction page.

2. The method of claim 1, wherein the step of associating content of the multimedia application to one or more interaction pages comprises mapping a region of the multimedia application to one or more interaction pages using an image map.

3. The method of claim 2, wherein mapped regions of the multimedia application are logically associated with data models for which user interaction is described using a modality independent, single authoring interaction-based programming paradigm.

4. The method of claim 1, wherein the step of associating content of a multimedia application to one or more interaction pages comprises transmitting low bit rate encoded meta information with a bit stream of the multimedia application.

5. The method of claim 4, wherein the low bit rate encoded meta information is transmitted in band or out of band.

6. The method of claim 4, wherein the encoded meta information describes a user interface that enables a user to control and manipulate streamed content.

7. The method of claim 6, wherein the user interface comprises one of a conversational, multi-modal and multi-channel user interface.

8. The method of claim 1, wherein the interaction pages comprise modality independent interaction pages that describe user interaction using a modality-independent script.

9. The method of claim 8, wherein the modality-independent script is one of declarative, imperative, and a combination thereof.

10. The method of claim 8, comprising the step of transcoding a modality-independent interaction page to a modality-specific interaction page.

11. The method of claim 1, wherein the step of presenting a user interface comprises presenting a multi-modal interface.

12. The method of claim 11, further comprising the step of synchronizing user interaction across all modalities provided by the multi-modal interface.

13. The method of claim 1, comprising the step of using different user agents for rendering multimedia content and an interactive user interface.

14. The method of claim 1, wherein the user interface enables a user to control presentation of the multimedia application.

15. The method of claim 1, wherein the user interface enables a user to control a source of the multimedia application.

16. The method of claim 1, further comprising the step of updating the interaction pages, or fragments thereof, during a multimedia presentation.

17. The method of claim 16, wherein the step of updating comprises selecting interaction pages, or fragments thereof, using a synchronizing application.

18. The method of claim 16, wherein the step of updating comprises using event driven coordination based on events that are thrown during a multimedia presentation.

19. A program storage device readable by a machine, tangibly embodying a program of instructions executable by the machine to perform method steps for implementing a multimedia application, the method steps comprising:
associating content of a multimedia application to one or more interaction pages; and
presenting a user interface that enables user interactivity with the content of the multimedia application using an associated interaction page.

20. The program storage device of claim 19, wherein the instructions for associating content of the multimedia application to one or more interaction pages comprise instructions for mapping a region of the multimedia application to one or more interaction pages using an image map.

21. The program storage device of claim 20, wherein mapped regions of the multimedia application are logically associated with data models for which user interaction is described using a modality independent, single authoring interaction-based programming paradigm.

22. The program storage device of claim 19, wherein the instructions for associating content of a multimedia application to one or more interaction pages comprise instructions for transmitting low bit rate encoded meta information with a bit stream of the multimedia application.

23. The method of claim 22, wherein the encoded meta information describes a user interface that enables a user to control and manipulate streamed content.

24. The program storage device of claim 23, wherein the user interface comprises one of a conversational, multi-modal and multi-channel user interface.

25. The program storage device of claim 19, comprising instructions for transcoding a modality-independent interaction page to a modality-specific interaction page.

26. The program storage device of claim 19, wherein the instructions for presenting a user interface comprise instructions for presenting a multi-modal interface.

27. The program storage device of claim 26, further comprising instructions for synchronizing user interaction across all modalities provided by the multi-modal interface.

28. The program storage device of claim 19, wherein different user agents are used for rendering multimedia content and an interactive user interface.

29. The program storage device of claim 19, wherein the user interface enables a user to control presentation of the multimedia application.

30. The program storage device of claim 19, wherein the user interface enables a user to control a source of the multimedia application.

31. The program storage device of claim 19, further comprising instructions for updating the interaction pages, or fragments thereof, during a multimedia presentation.

32. The program storage device of claim 31, wherein the instructions for updating comprise instructions for selecting interaction pages, or fragments thereof, using a synchronizing application.

33. The program storage device of claim 31, wherein the instructions for updating comprise instructions for using event driven coordination based on events that are thrown during a multimedia presentation.

34. A system for enabling interactivity with a multimedia presentation, the system comprising:
a server for associating content of a multimedia application to one or more interaction pages; and
a client for rendering and presenting a user interface that enables user interactivity with the content of the multimedia application using an associated interaction page.

35. The system of claim 34, wherein the server comprises:
a first database comprising a multimedia application and one or more image maps and interaction pages that are associated with the multimedia application; and
a second database for storing mapping information that maps a portion of the multimedia application to an interaction page; and
a coordinator for coordinating interaction pages with the multimedia application.

36. The system of claim 34, wherein the client comprises a multi-modal browser that parses an interaction page and generates a modality-specific script representing the interaction page.

37. The system of claim 34, wherein the client comprises a browser that enables a user to control presentation of the multimedia application or control a source of the multimedia application.

38. The system of claim 34, wherein the client comprises a first user agent for rendering multimedia content and a second user agent for rendering an interactive user interface.
